(19) United States
(12) Patent Application Publication
(10) Pub. No.: US 2023/0384487 A1
(43) Pub. Date: Nov. 30, 2023

(54) Micro Lens Array, Diffuser Plate, and Illumination Apparatus

(71) Applicant: Daicel Corporation, Osaka (JP)

(72) Inventor: Makoto Yasuhara, Tokyo (JP)

(73) Assignee: Daicel Corporation, Osaka (JP)

(21) Appl. No.: 18/202,211

(22) Filed: May 25, 2023

(30) Foreign Application Priority Data
May 25, 2022 (JP) 2022-085148

(51) Int. Cl. G02B 3/00; G01S 7/481

(52) U.S. Cl. CPC G02B 3/0056; G01S 7/4817

(57) ABSTRACT

A micro lens array including a honeycomb structure including columns of the lens elements alternately arrayed, each of the lens elements having a shape of a hexagon in a plan view and being linearly arranged such that sides of the hexagon in a predetermined direction are in contact with each other, wherein a mathematical expression indicating a SAG of the lens element includes a term of A_{xmyn}X^{m}Yⁿ (m and n are integers except 0), in a case where, when an optical axis of the lens element is an origin, Y is a coordinate in an arrangement direction of the lens elements in the columns of the lens elements, X is a coordinate in an array direction in which the columns of the lens elements are alternately arrayed, and A is a predetermined coefficient.

### CROSS-REFERENCE TO RELATED APPLICATION

This application is based upon and claims the benefit of priority of the prior Japanese Patent Application No. 2022-085148, filed on May 25, 2022, the entire contents of which are incorporated herein by reference.

### TECHNICAL FIELD

The present invention relates to a micro lens array, a diffuser plate, and an illumination apparatus.

### BACKGROUND ART

For example, a known micro lens array has a plurality of lens elements arranged and is used for an apparatus for illumination, measurement, facial recognition, spatial recognition, and the like (see for example, Patent Document 1). When such a micro lens array is used for the purpose of optically making light from a light source uniform, and if a pitch between the lens elements is too small, interference fringes due to interference of light transmitted between the lens elements becomes obvious and may hinder the uniformity of light-source light. On the other hand, when the pitch between the lens elements is too large, the light irradiated from the light source is non-uniformly incident on the micro lens array, which cause moire fringes and may result in non-uniform irradiation distribution. As a result, when a screen or the like is irradiated with light from the light source using the micro lens array, the illuminance distribution in the irradiation pattern may become non-uniform. FIG. 16A illustrates an example of the illuminance distribution in the irradiation pattern without interference fringes or moire fringes, FIG. 16B illustrates an example of the illuminance distribution in the irradiation pattern in a case where interference fringes are produced, and FIG. 16C illustrates an example of the illuminance distribution in the irradiation pattern in a case where moire fringes are produced.

To suppress the non-uniformity of the illuminance distribution in the irradiation pattern due to the interference fringes described above, a countermeasure of randomly distributing the position, shape, and the like of each lens element has been considered (for example, see Patent Document 2, Patent Document 3, and the like). Unfortunately, excessive randomization may not provide desired light distribution characteristics, and in particular, may make it difficult to sharpen an edge of an irradiation profile. Furthermore, a complicated array of the lens elements may cause disadvantages such as a long production time and a high production cost.

In addition, as a measure for suppressing the non-uniformity of the illuminance distribution in the irradiation pattern due to the interference fringes while the array of the lens elements is made regular, a measure in which hexagonal lens elements are arrayed in a honeycomb shape is considered. A technique itself of arraying hexagonal lens elements in a honeycomb shape is known (for example, Patent Literature 4).

However, in a case where the hexagonal lens elements are arrayed in a honeycomb shape, an outer shape of an irradiation pattern of irradiation light by the micro lens array also becomes a hexagonal shape, and when light is received by a normal light receiving element, there is a case where a decrease in efficiency or peripheral dimming is promoted.

### CITATION LIST

### Patent Document

Patent Document 1: WO 2005/103795
Patent Document 2 WO 2004/027495
Patent Document 3 WO 2015/182619
Patent Document 4: JP 2014-139656

### SUMMARY OF INVENTION

### Technical Problem

The technique of the present disclosure is invented in view of the above, and an advantage of some aspects of the invention is to provide a technique of obtaining a more uniform and highly efficient illuminance distribution by a micro lens array.

Solution to Problem

To solve the above problems, a micro lens array according to the present disclosure is a micro lens array in which a plurality of lens elements are arranged on at least one surface of a planar member, the micro lens array including a honeycomb structure including columns of the lens elements alternately arrayed, each of the lens elements having a shape of a hexagon in a plan view and being linearly arranged such that sides of the hexagon in a predetermined direction are in contact with each other, wherein a mathematical expression indicating a SAG of the lens element includes a term of A_{xmyn}X^{m}Yⁿ (m and n are integers except 0), in a case where, when an optical axis of the lens element is an origin, Y is a coordinate in an arrangement direction of the lens elements in the columns of the lens elements, X is a coordinate in an array direction in which the columns of the lens elements are alternately arrayed, and A is a predetermined coefficient.

Thus, the SAG can be controlled for each (X, Y) coordinate in the lens element by making the mathematical expression indicating SAG of the lens element include the term of A_{xmyn}X^{m}Yⁿ (m and n are integers except 0) and appropriately determining the coefficient A_{xmyn}. Then, it makes it possible to control the aspherical shape in the oblique direction having an angle with respect to the arrangement direction of the lens elements in the columns of the lens elements in each lens shape. This makes it possible to control the outer shape of the irradiation pattern of the irradiation light that has passed through the micro lens array. As a result, the outer shape of the irradiation pattern can be adjusted in accordance with the shape of the light receiving surface of the light receiving element, the efficiency of the optical system can be increased, or the peripheral dimming of the light receiving surface can be suppressed. In other words, the outer shape of the irradiation pattern in the present disclosure can also be referred to as an illuminance distribution in the irradiation pattern.

In addition, in the present disclosure, a mathematical expression indicating the SAG of the lens element is represented by

$$\begin{matrix}[ Math . 1 ] & \\ Z = \frac{C {r}^{2}}{1 + \sqrt{1 - ( 1 + K ) {C}^{2} {r}^{2}}} + Σ {A}_{xmyn} {X}^{m} {Y}^{n} & ( 1 )\end{matrix}$$

in a case where, when an optical axis of the lens element is an origin, Y is a coordinate in the arrangement direction of the lens elements in the columns of the lens elements, X is a coordinate in the array direction in which the columns of the lens elements are alternately arrayed, C is a curvature of a lens surface, and K is a conical coefficient of the lens surface in the lens element.

According to this, by appropriately determining the coefficient A_{xmyn}, the arrangement direction of the lens elements in the columns of the lens elements and the SAG in the array direction of the columns of the lens elements can independently be determined, and the lens shape as the non-rotating body shape with respect to the optical axis can more easily be defined.

In the above description, m and n may be even numbers. According to this configuration, it is easy to configure a lens shape which is point-symmetric about the optical axis in each lens element. Further, the mathematical expression indicating the SAG of the lens elements may include the term of A_{x2y2}X²Y². According to this, by changing the coefficient A_{xmyn}, the lens shape in the vicinity of the optical axis can be changed more greatly, and the lens shape can be controlled more efficiently.

The present disclosure may be a micro lens array in which a plurality of lens elements are arranged on at least one surface of a planar member, the micro lens array including
a honeycomb structure in which columns of the lens elements are alternately arrayed, each of the lens elements having a shape of a hexagon in a plan view and being linearly arranged such that sides of the hexagon in a predetermined direction are in contact with each other, wherein
in a case where, when an optical axis of the lens element is an origin, a Y direction is an arrangement direction of the lens elements in the columns of the lens elements, and an X direction is an array direction in which the columns of the lens elements are alternately arrayed,
in a direction of a predetermined angle range between the X direction and the Y direction when viewed from the origin, the SAG in accordance with a distance r from the optical axis deviates from a range between the SAG in the X direction and the SAG in the Y direction.

According to this configuration, the SAG on the lens surface can be set to be greater or less than the SAG in the X direction and the Y direction in the direction of the predetermined angle range between the X direction and the Y direction when viewed from the origin in each lens shape. This makes it possible to appropriately control the aspherical shape of the lens shape of each lens element in a direction oblique to the X direction and the Y direction.

In addition, a micro lens array according to the present disclosure may be a micro lens array in which a plurality of lens elements are arranged on at least one surface of a planar member, the micro lens array including
a honeycomb structure in which columns of the lens elements are alternately arrayed, each of the lens elements having a shape of a hexagon in a plan view and being linearly arranged such that sides of the hexagon in a predetermined direction are in contact with each other, wherein
15≤a≤35 is satisfied where a is an apex angle of two sides which are not in contact with front and rear lens elements in the columns of the lens elements in the shape of the hexagon, k is an aspect ratio obtained by dividing a second pitch by a first pitch, the second pitch being a pitch of the plurality of lens elements in an array direction in which the columns of the lens elements are alternately arrayed, the first pitch being a pitch of the lens elements in an arrangement direction in the columns of the lens elements, and a is a value of (α−90)/k.

Here, it has been found that the irradiation pattern in the micro lens array having the honeycomb structure can be changed by changing the numerical value of a described above. It has been found by experiment or simulation that when the value of the parameter a is relatively great, the irradiation pattern has an outer shape approximate to a hexagon, and when the value of the parameter a is less, the irradiation pattern changes from a rectangular shape to a quadrilateral shape such that each side is curved inward. If the outer shape of the irradiation pattern is approximate to a hexagon, the irradiation pattern protrudes from the light receiving surface of the light receiving element, or promotes peripheral dimming.

On the other hand, when the irradiation pattern has a rectangular shape or a quadrilateral shape such that each side is curved inward, the amount of light with which the irradiation pattern protrudes from the light receiving surface of the light receiving element can be reduced, and the amount of light with which the four corners of the light receiving element are irradiated can relatively be increased. According to this configuration, by controlling the lens shape such that the value of one parameter falls within a target range, the shape of the irradiation pattern of the micro lens array having the honeycomb structure can be controlled, and the light receiving efficiency on the light receiving surface of the light receiving element and the peripheral dimming on the light receiving surface can be controlled. More specifically, in a case where the irradiation pattern is approximated to a rectangular shape, the light receiving efficiency on the light receiving surface of the light receiving element can be improved and the peripheral dimming on the light receiving surface can be controlled. In addition, when the irradiation pattern is approximated to a quadrilateral shape such that each side is curved inward, the peripheral dimming particularly on the light receiving surface can remarkably be suppressed.

In addition, in the present disclosure, a second pitch which is a pitch in an array direction in which the columns of the lens elements are alternately arrayed may be larger than a first pitch which is a pitch of the plurality of lens elements in the arrangement direction of the lens elements in the columns of the lens elements. According to this configuration, the shape of the lens element can be made more horizontally long, and the aspect ratio k can be increased. As a result, the value of the parameter a can be made relatively less, the shape of the irradiation pattern of the micro lens array can be easily formed into a rectangular shape or a quadrilateral shape such that each side is curved inward, and the light receiving efficiency on the light receiving surface of the light receiving element and the peripheral dimming on the light receiving surface can be easily controlled.

In addition, in the present disclosure, in the shape of the hexagon, an apex angle of two sides which are not in contact with front and rear lens elements in the columns of the lens elements may be 125 degrees or less. According to this configuration, the value of the apex angle α can be made relatively less. As a result, the value of the parameter a can be made relatively less, the shape of the irradiation pattern of the micro lens array can be changed from a rectangular shape to a quadrilateral shape such that each side is curved inward, and the light receiving efficiency on the light receiving surface of the light receiving element and the peripheral dimming on the light receiving surface can be controlled.

In addition, in the present disclosure, an intensity pattern of light transmitted through the micro lens array may have a substantially rectangular shape or a substantially quadrilateral shape such that each side is curved inward. According to this configuration, for the above-described reason, the light receiving efficiency on the light receiving surface of the light receiving element and the peripheral dimming on the light receiving surface can be controlled.

In addition, the present disclosure may be a diffuser plate using the micro lens array described above.

In addition, the present disclosure may be an illumination apparatus including: the micro lens array described above; and a light source configured to emit light incident on the micro lens array. In this case, the lens elements in the micro lens array may be arrayed on a surface on the light source side. The directivity of the light source may be ±20° or less. The light source may be a laser light source that emits near-infrared light.

The illumination apparatus may be used in distance measuring equipment. Further, the present invention may be used in distance measuring equipment using a Time Of Flight system.

Note that, in the present invention, wherever possible, the techniques for solving the above-described problem can be used in combination.

### Advantageous Effects of Invention

According to the present disclosure, a more uniform and highly efficient illuminance distribution can be obtained by the micro lens array.

### BRIEF DESCRIPTION OF DRAWINGS

FIG. 1 is a diagram illustrating a schematic configuration of distance measuring equipment using a Time Of Flight system.

FIG. 2 is a schematic diagram of a system in which light emitted from a light source passes through a micro lens array and a screen is irradiated with the light, and a diagram illustrating an irradiation pattern.

FIG. 3A, FIG. 3B and FIG. 3C are diagrams illustrating a relationship between a shape of a lens element of the micro lens array and an irradiation pattern to be obtained.

FIG. 4A and FIG. 4B are diagrams comparing the curvature in the X direction, the curvature in the Y direction, and the curvature in the 0 direction between the X direction and the Y direction in the lens element of the micro lens array.

FIG. 5 is a diagram illustrating an outline of a honeycomb structure in the micro lens array.

FIG. 6 is a graph illustrating a relationship between an aspect ratio of the lens element in the micro lens array, the apex angle α of a lens element, and a parameter a.

FIG. 7A, FIG. 7B and FIG. 7C are diagrams illustrating a relationship between the parameter a and the aspect ratio k of the lens element in the micro lens array, and an outer shape of the irradiation pattern.

FIG. 8A, FIG. 8B and FIG. 8C are second diagrams illustrating the relationship between the parameter a and the aspect ratio k of the lens element in the micro lens array and the outer shape of the irradiation pattern.

FIG. 9A and FIG. 9B are third diagrams illustrating the relationship between the parameter a and the aspect ratio k of the lens element in the micro lens array, and the outer shape of the irradiation pattern.

FIG. 10A, FIG. 10B and FIG. 10C are fourth diagrams illustrating the relationship between the parameter a and the aspect ratio k of the lens element in the micro lens array, and the outer shape of the irradiation pattern.

FIG. 11A and FIG. 11B are fifth diagrams illustrating the relationship between the aspect ratio k of the lens element in the micro lens array and the outer shape of the irradiation pattern.

FIG. 12 is a graph showing the relationship between the parameter a, the aspect ratio k, and an efficiency.

FIG. 13 is a graph showing the relationship between the parameter a, the aspect ratio k, and the peripheral portion/center intensity ratio in the irradiation pattern.

FIG. 14 is a perspective view of a diffuser plate in which the micro lens array is formed on a surface of a flexible sheet.

FIG. 15 is a diagram illustrating a schematic configuration of an illumination apparatus.

FIG. 16A, FIG. 16B and FIG. 16C illustrate examples of irradiance distribution in the case where interference fringes and moire fringes are not generated on the screen with respect to light passing through the micro lens array and in the case where interference fringes and moire fringes are generated.

### DESCRIPTION OF EMBODIMENTS

A micro lens array according to an embodiment of the present disclosure will be described below with reference to the drawings. Note that each of the configurations, combinations thereof, and the like in the embodiment are an example, and various additions, omissions, substitutions, and other changes may be made as appropriate without departing from the spirit of the present disclosure. The present disclosure is not limited by the embodiment and is limited only by the claims.

### First Embodiment

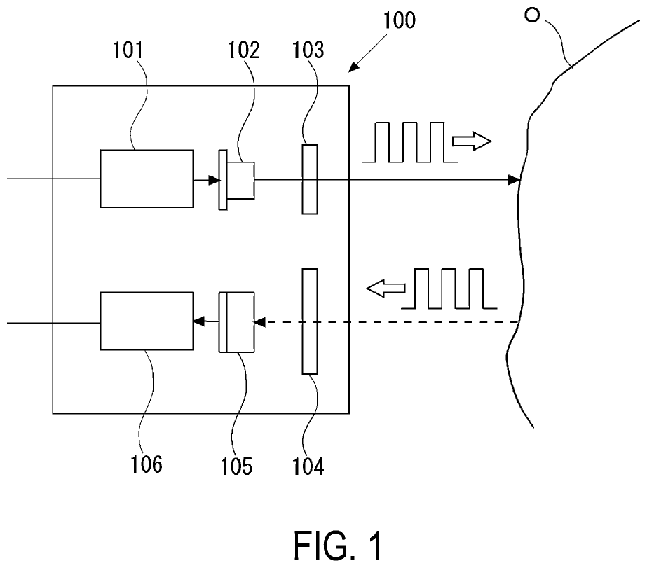

FIG. 1 is a schematic view illustrating distance measuring equipment 100 using a Time Of Flight (TOF) system, as an example of an application of a micro lens array according to an embodiment. The distance measuring equipment 100 using the TOF system measures a distance to each part of a surface of a measurement target O by measuring time-of-flight of irradiation light, and includes a light source control unit 101, an irradiation light source 102, an irradiation optical system 103, a light receiving optical system 104 that collects reflected light from the measurement target a light receiving element 105, and a signal processing circuit 106.

When the irradiation light source 102 emits pulsed light based on a drive signal from the light source control unit 101, the pulsed light passes through the irradiation optical system 103 and is emitted onto the measurement target O. The reflected light reflected on the surface of the measurement target O passes through the light receiving optical system 104, is received by the light receiving element 105, and then is converted into an appropriate electrical signal by the signal processing circuit 106. Then, a calculation unit (not illustrated) measures the distance to each location on the measurement target O by measuring the time from when the irradiation light is emitted from the irradiation light source 102 until the light receiving element 105 receives the reflected light, that is, the time-of-flight of the light.

For the irradiation optical system 103 or the light receiving optical system 104 in the distance measuring equipment 100 using the TOF system, a micro lens array may be used. The micro lens array is a lens array formed by the group consisting of micro lens elements having a diameter in a range of about 10 μm to several millimeters. In general, the function and accuracy of the micro lens array vary depending on characteristics such as the shape (spherical, aspherical, cylindrical, hexagonal, or the like) of each lens element constituting the lens array, the size of the lens element, the arrangement of the lens elements, and the pitch between the lens elements.

When the micro lens array is used for the distance measuring equipment 100 using the TOF system described above, the measurement target O is required to be irradiated with light with a uniform intensity distribution. That is, the angle of view θ_{FOI} (FOI: Field of Illumination) that is a usable divergence angle of light that has passed through the micro lens array is determined according to the size of the measurement target O or the measurement distance, but in the range of the angle of view θ_{FOI}, the uniformity of the irradiance distribution of the light that has passed through the micro lens array may be required. As described above, the micro lens array is required to have characteristics corresponding to the purpose of use.

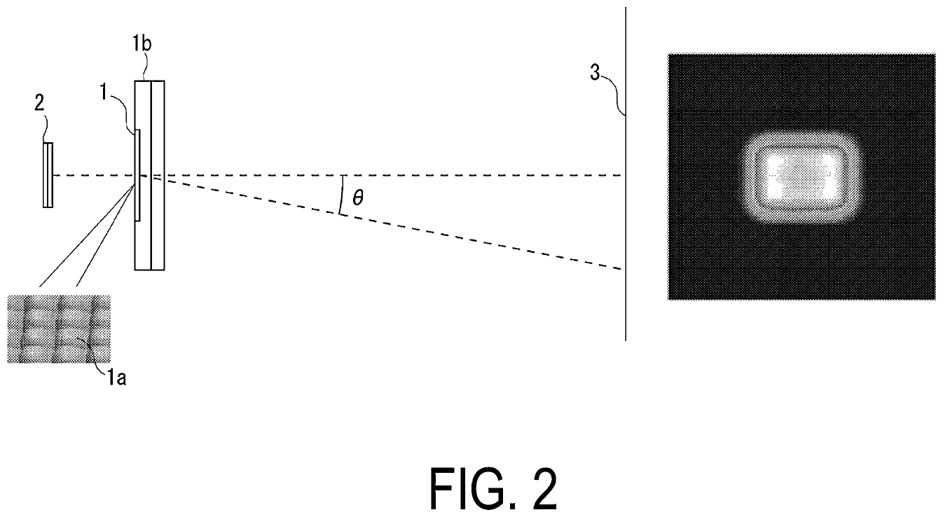

Next, as illustrated in FIG. 2, a system in which light emitted from a light source 2 passes through a micro lens array 1 and is emitted onto a screen 3 will be considered. Here, the light source 2 is, for example, a vertical cavity surface emitting laser (VCSEL) light source, and the directivity of the light source 2 can be selected from approximately ±5 degrees, ±10 degrees, and ±20 degrees, but is not particularly limited. The micro lens array 1 formed by forming an array, in which lens elements 1a are two-dimensionally arrayed, is provided on one or both side surfaces of a base material that is a planar member, and the light that has passed through the micro lens array 1 turns into diffused light that diffuses with respect to an optical axis, and is emitted onto the screen 3 simulating the measurement target O. Then, an irradiation pattern corresponding to the characteristics of the micro lens array 1 is formed on the screen 3.

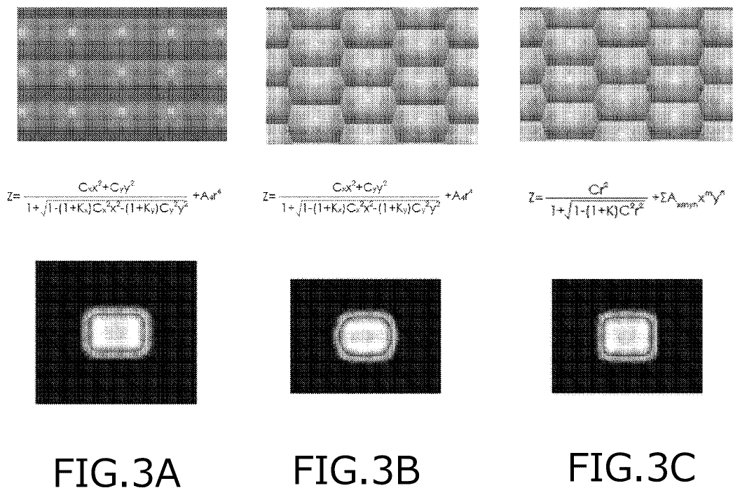

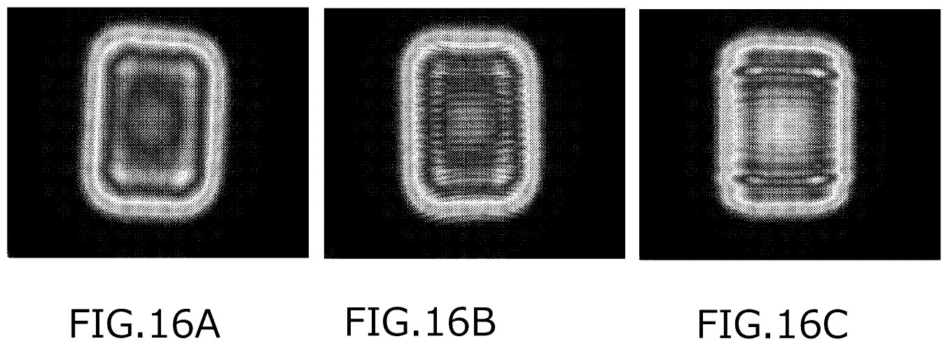

Here, as illustrated in FIG. 3A, for example, in a micro lens array in which lens elements having a rectangular outer shape are simply arranged vertically and horizontally, an irradiation pattern having a substantially rectangular outer shape is obtained on the screen 3. On the other hand, depending on conditions such as the pitch of the lens elements 1a, interference fringes as illustrated in FIG. 16A, FIG. 16B and FIG. 16C may be generated in the irradiation pattern. To suppress the generation of the interference fringes, it is desirable to reduce the uniformity of the arrangement of the lens elements 1a in the micro lens array, and as illustrated in FIG. 3B, a honeycomb structure in which the outer shape of the lens elements 1a is hexagonal and the columns in which the hexagonal lens elements are linearly arranged are alternately arranged has been adopted in some cases. However, in this case, although the generation of interference fringes can be suppressed, the irradiation pattern of the micro lens array may also be hexagonal as illustrated in the lower part of FIG. 3B. In this case, since the light receiving surface of the light receiving element is often rectangular, the consistency between the outer shape of the irradiation pattern and the shape of the light receiving surface of the light receiving element is reduced, and thus the light receiving efficiency may be reduced or the peripheral dimming of the light receiving surface may be promoted.

On the other hand, in the present embodiment, by controlling the aspherical shape of the lens surface of each hexagonal lens element, the irradiation pattern can be controlled to have a rectangular shape as illustrated in FIG. 3C. As a result, the generation of interference fringes can be suppressed, the consistency between the outer shape of the irradiation pattern and the shape of the light receiving surface of the light receiving element can be improved, the light receiving efficiency can be increased, and the peripheral dimming can be suppressed. Here, the light receiving efficiency may be, for example, a ratio of the intensity of light emitted on the light receiving surface of the light receiving element to the entire intensity of the irradiation pattern by the micro lens array.

More specifically, as an expression indicating the SAG on the lens surface of the lens element, an aspheric expression (1) as illustrated in the middle part of FIG. 3C is adopted.

$$\begin{matrix}[ Math . 2 ] & \\ Z = \frac{C {r}^{2}}{1 + \sqrt{1 - ( 1 + K ) {C}^{2} {r}^{2}}} + Σ {A}_{xmyn} {X}^{m} {Y}^{n} & ( 1 )\end{matrix}$$

Here, Y is the coordinate in the vertical direction in FIG. 3C when the optical axis of the lens element 1a is the origin, X is the coordinate in the horizontal direction in FIG. 3C, C is the radius of curvature of the lens surface, and K (uppercase letter) is a conical coefficient of the lens surface. In FIG. 3C, the SAG in the oblique direction with respect to the X direction and the Y direction is controlled by appropriately determining the coefficient A_{xmyn}, whereby the irradiation pattern is made approximate to a rectangular shape from a hexagon.

Here, the mathematical expression describing the SAG on the lens surface of the lens element 1a is not limited to the above expression (1). For example, the mathematical expression describing the SAG may include the term of A_{xmyn}X^{m}Yⁿ (m and n are integers except 0). Thus, SAG can be controlled for each (X, Y) coordinate in the lens element 1a by making the mathematical expression indicating SAG of the lens element 1a include the term of A_{xmyn}X^{m}Yⁿ (m and n are integers except 0) and appropriately determining the coefficient A_{xmyn}. Then, the aspherical shape in the oblique direction having an angle with respect to the arrangement direction of the lens elements in the columns of the lens elements can be controlled in each lens shape. Thus, the irradiation pattern can be controlled to have a rectangular shape as illustrated in FIG. 3C.

Note that in the term of A_{xmyn}X^{m}Yⁿ, m and n may be even numbers. According to this configuration, it is easy to configure a lens shape which is point-symmetric about the optical axis in each lens element. Further, the mathematical expression describing the SAG of the lens element 1a may include the term of A_{x2y2}X²Y². According to this configuration, by changing the coefficient A_{x2y2}, the lens shape in the vicinity of the optical axis can be changed more greatly. Thus, the lens shape can be controlled more efficiently, and the shape of the irradiation pattern can be controlled more efficiently.

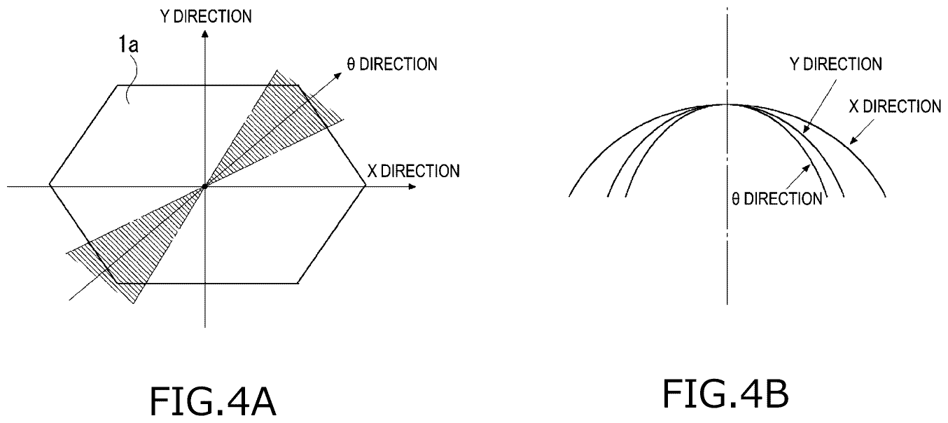

As a result of controlling the SAG in the oblique direction with respect to the X direction and the Y direction in the lens shape of the lens element 1a as described above, the SAG on the lens surface may deviate from the range between the SAG in the X direction and the SAG in the Y direction at the same distance r from the optical axis as illustrated in FIG. 4B in the direction of a predetermined angle range between the X direction and the Y direction as viewed from the origin of the lens element 1a as illustrated in FIG. 4A, for example, in the 0 direction in the angle range hatched in the drawing. That is, in the typical lens element 1a having an aspherical shape, if the SAGs in the X direction and the Y direction at the same distance r from the optical axis are different when viewed from the origin of the lens element 1a, the SAG on the lens surface often has a value between the SAG in the X direction and the SAG in the Y direction at the same distance r from the optical axis in an oblique direction between the X direction and the Y direction. This is because the lens shape is often a shape such that the SAG gradually changes in the circumferential direction of the lens element 1a, for example, from the X direction to the Y direction.

On the other hand, in the present disclosure, the SAG on the lens surface deviates from the range between the SAG in the X direction and the SAG in the Y direction at the same distance r from the optical axis in the direction of the predetermined angle range between the X direction and the Y direction when viewed from the origin of the lens element 1a. As a result, for example, in the θ direction in FIG. 4A, as illustrated in FIG. 4B, the SAG on the lens surface can be largely changed, and thus the shape of the irradiation pattern can be largely changed. For example, in the θ direction between the X direction and the Y direction, the SAG on the lens surface may be greater than both the SAG in the X direction and the SAG in the Y direction at the same distance r from the optical axis. Alternatively, in the θ direction between the X direction and the Y direction, the SAG on the lens surface may be less than both the SAG in the X direction and the SAG in the Y direction at the same distance r from the optical axis.

More specifically, in the case where the light receiving surface of the light receiving element is quadrangular and the irradiation pattern by the micro lens array 1 is hexagonal, when the entire irradiation pattern is emitted on the light receiving surface, light is not emitted on the four corners of the light receiving surface, and peripheral dimming is promoted. On the other hand, when sufficient light is emitted to the four corners of the light receiving surface, the ratio of the irradiation light emitted to the outside of the light receiving surface increases, and the efficiency decreases. On the other hand, by making the outer shape of the irradiation pattern approximate to a rectangular shape, the efficiency can be improved and the peripheral dimming can be suppressed.

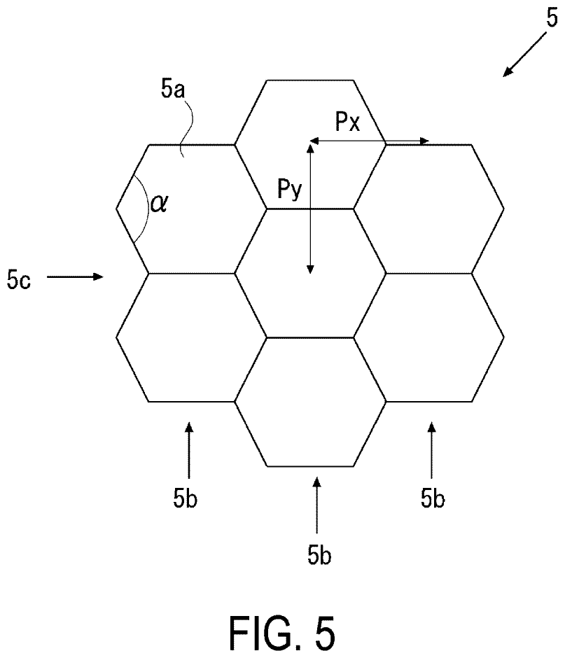

Next, another index of the above-described aspherical surface expression (1), which characterizes the irradiation pattern shape of the micro lens array having the honeycomb structure, will be described. FIG. 5 is a schematic view of a honeycomb structure in a micro lens array 5. Each hexagon in the figure represents a lens element 5a. The honeycomb structure has a shape such that columns 5b of the lens elements 5a arranged, and thus the facing parallel sides of the hexagons representing the lens elements 5a are in contact with each other are alternately arranged. The arrangement direction of the lens elements 5a in the columns 5b of the lens elements 5a corresponds to the vertical direction in FIG. 3C, that is, the Y direction (hereinafter, simply referred to as the Y direction). In addition, the array direction in which the columns 5b of the lens elements 5a are alternately arrayed (the direction of the arrow in FIG. 5) corresponds to the horizontal direction in FIG. 3C, that is, the X direction (hereinafter, simply referred to as the X direction).

When an apex angle between two sides where the lens elements 5a are not in contact with each other in the columns 5b of the lens elements 5a is a (hereinafter, simply referred to as an apex angle α in the X direction), a pitch of the lens elements in the Y direction is Py, and a pitch of the lens elements 5a in the X direction is Px, it is assumed that the following relationship

α=a·k+90(deg) (2)

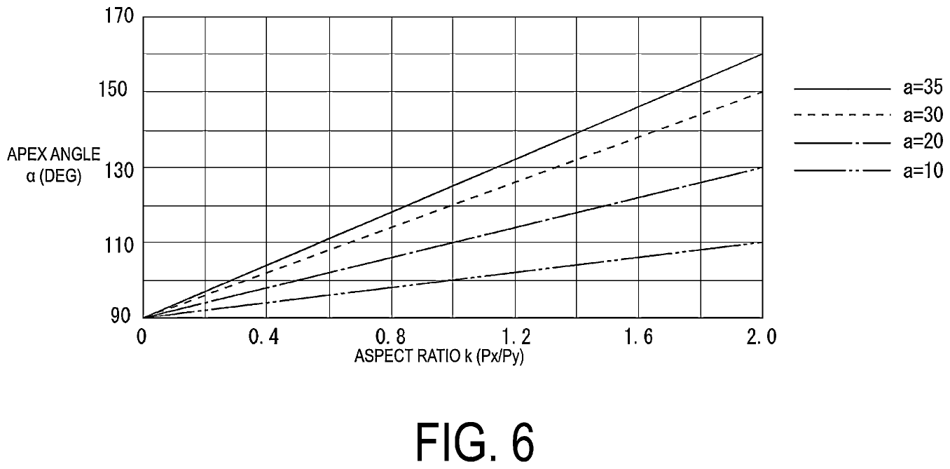

is satisfied between an aspect ratio k=Px/Py and the apex angle α in the X direction (a is a parameter defined in the present embodiment). In the present embodiment, the parameter a is used as an index to evaluate the characteristics of the irradiation pattern of the micro lens array 5. FIG. 6 is a graph illustrating the relationship between the aspect ratio k and the apex angle α in the X direction when the value of the parameter a is changed. This relationship is calculated based on the expression (2). The parameter a can be defined as in the following expression (3) by modifying the expression (2).

a=(α−90)/k (3)

In FIG. 5, Py corresponds to the first pitch in the present disclosure, and Px corresponds to the second pitch in the present disclosure.

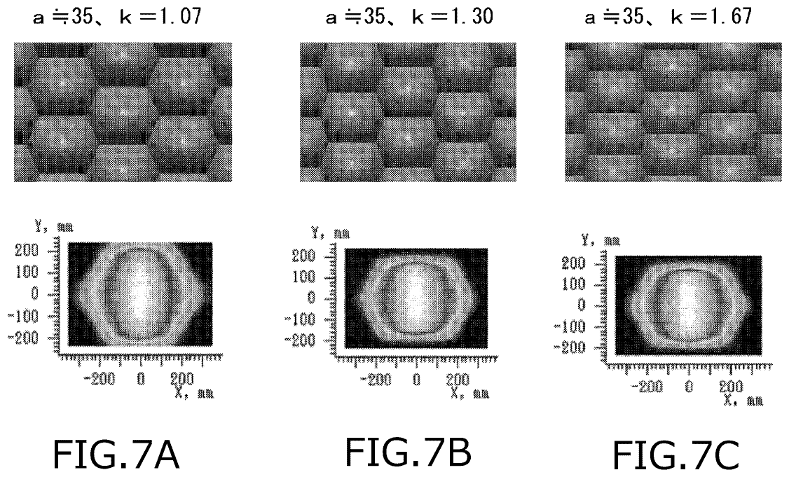

FIG. 7A, FIG. 7B and FIG. 7C illustrate the relationship between the parameter a, the aspect ratio k, and the characteristics of the irradiation pattern of the micro lens array 5. FIG. 7A illustrates a case where the parameter a≈35 and the aspect ratio k=1.07, FIG. 7A illustrates a case where the parameter a≈35 and the aspect ratio k=1.30, and FIG. 7C illustrates a case where the parameter a≈35 and the aspect ratio k=1.67. As illustrated in FIG. 7A, FIG. 7B and FIG. 7C, when the parameter a is the same, as the aspect ratio k increases, the lens elements 5a in the honeycomb structure become longer in the horizontal direction. It can also be seen that the value of the apex angle α in the X direction increases. In addition, the shape of the irradiation pattern is hexagonal in any case, which is disadvantageous in terms of efficiency and peripheral dimming. The value of the apex angle α in the X direction in FIG. 7A is 127.5 (deg), the value of the apex angle α in the X direction in FIG. 7B is 135.5 (deg), and the value of the apex angle α in the X direction in FIG. 7C is 148.5 (deg), and in any case, the apex angle α in the X direction is greater than 125 (deg).

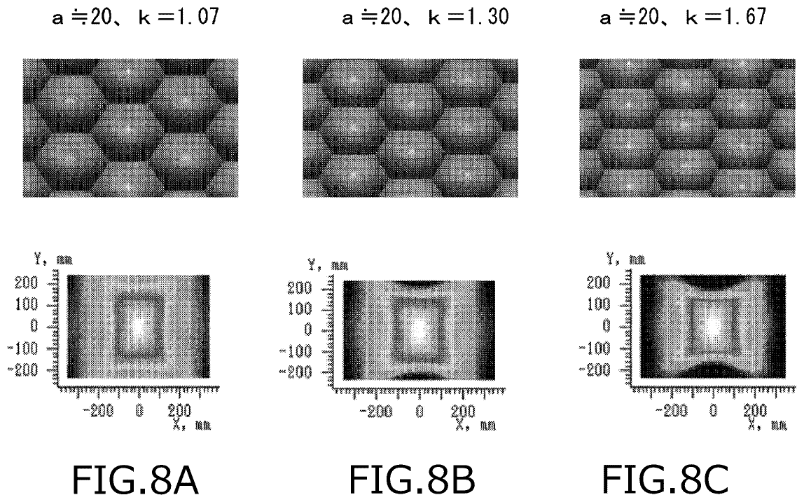

Next, FIG. 8A, FIG. 8B and FIG. 8C illustrate second examples of the relationship between the parameter a and the aspect ratio k, and the characteristics of the irradiation pattern of the micro lens array 5. FIG. 8A illustrates a case where the parameter a≈20 and the aspect ratio k=1.07, FIG. 8B illustrates a case where the parameter a≈20 and the aspect ratio k=1.30, and FIG. 8C illustrates a case where the parameter a≈20 and the aspect ratio k=1.67. As illustrated in FIG. 8A, FIG. 8B and FIG. 8C, the shape of the irradiation pattern is approximate to a rectangular shape than in the case of a≈30, or is a quadrilateral shape such that each side is curved inward. This is more advantageous in terms of efficiency and peripheral dimming. Note that the value of the apex angle α in the X direction in FIG. 8A is 111.4 (deg), the value of the apex angle α in the X direction in FIG. 8B is 116 (deg), and the value of the apex angle α in the X direction in FIG. 8C is 123.4 (deg), and in all cases, the apex angle α in the X direction is less than 125 (deg). When the apex angle α in the X direction in FIG. 7A, FIG. 7B and FIG. 7C are compared with the apex angle α in the X direction in FIG. 8A, FIG. 8B and FIG. 8C, there is also a correlation between the apex angle α in the X direction and the characteristics of the irradiation pattern, and it can be said that a value of the apex angle α in the X direction of 125 (deg) or less is more advantageous in terms of efficiency and peripheral dimming.

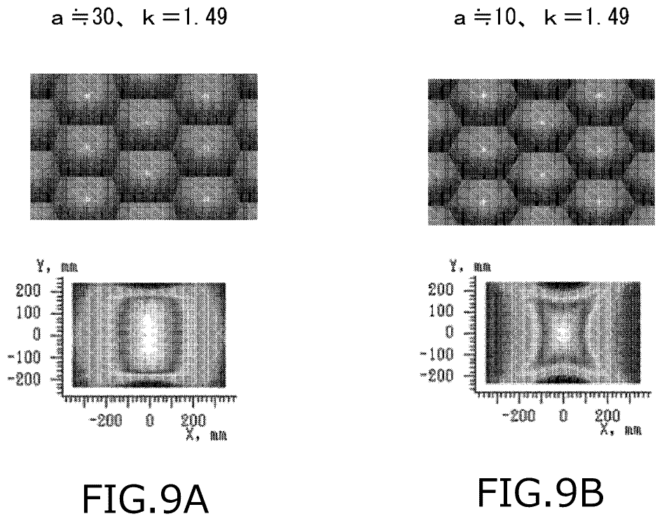

FIG. 9A and FIG. 9B illustrates a third example of the relationship between the parameter a and the aspect ratio k, and the characteristics of the irradiation pattern of the micro lens array 5. FIG. 9A illustrates a case where the parameter a≈30 and the aspect ratio k=1.49, and FIG. 9B illustrates a case where the parameter a≈10 and the aspect ratio k=1.49. As illustrated in FIG. 9A and FIG. 9B, when the aspect ratio k is the same, the shape of the irradiation pattern is such that the degree of inward curvature of each side of the quadrilateral shape is stronger in the case of a than in the case of a≈30. The value of the apex angle α in the X direction in FIG. 9A is 134.7 (deg) and the value of the apex angle α in the X direction in FIG. 9B is 104.9 (deg), and in the case of FIG. 9B where the apex angle α in the X direction is less than 125 (deg), the outward curvature of each side of the outer shape of the irradiation pattern is not seen, which is more advantageous in terms of efficiency and peripheral dimming.

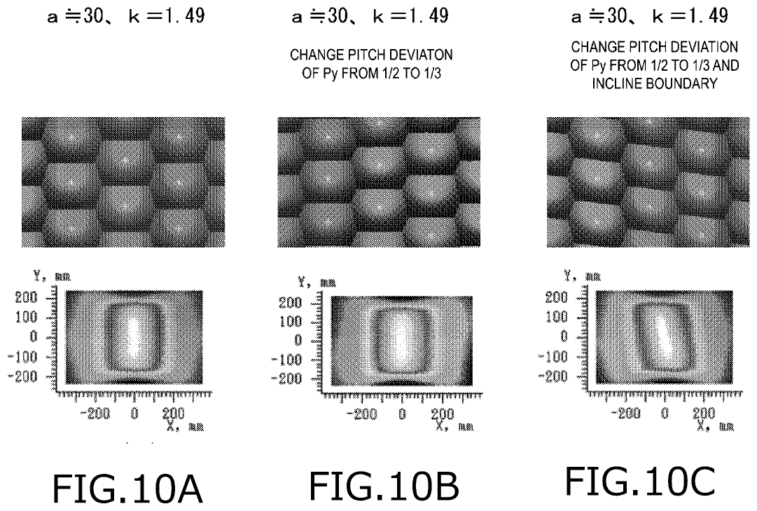

FIG. 10A, FIG. 10B and FIG. 10C illustrate fourth examples of the relationship between the parameter a and the aspect ratio k, and the characteristics of the irradiation pattern of the micro lens array 5. FIG. 10A illustrates a case where the parameter a≈30 and the aspect ratio k=1.49. FIG. 10B illustrates a case where the parameter a≈30, the aspect ratio k=1.49, and the pitch Py is changed from ½ to ⅓. FIG. 10C illustrates a case where a side where the lens elements 5a are in contact with each other in the columns 5b of the lens elements 5a is inclined. As illustrated in FIG. 10B, by changing the deviation of the pitch Py from ½ to ⅓, the shape of the irradiation pattern can be a parallelogram shape. Further, as illustrated in FIG. 10C, it can be seen that the outer shape of the irradiation pattern can be corrected to a rectangular shape by further inclining the side where the lens elements 5a are in contact with each other in the columns 5b of the lens elements 5a.

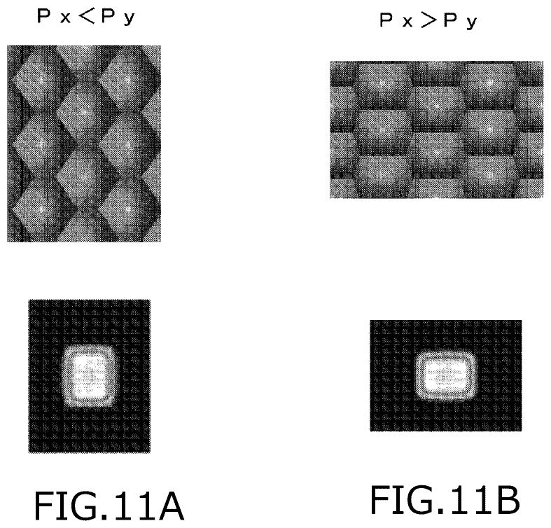

FIG. 11A and FIG. 11B illustrates a fifth example of the relationship between the parameter a and the aspect ratio k, and the characteristics of the irradiation pattern of the micro lens array 5. FIG. 11A illustrates the case of Px<Py at the aspect ratio k, and FIG. 11B illustrates the case of Px>Py at the aspect ratio k. In this way, the magnitude relationship between Px and Py can be selected in accordance with a desired irradiation pattern. Thereby, the aspect ratio of the irradiation pattern itself can also be controlled. Here, in many apparatuses, a light receiving element having a horizontally long rectangular light receiving surface is often used, and if an aspect ratio of Px>Py is set as the aspect ratio of the micro lens array 5 as illustrated in FIG. 11B, the micro lens array 5 can be more easily applied to more apparatuses as it is.

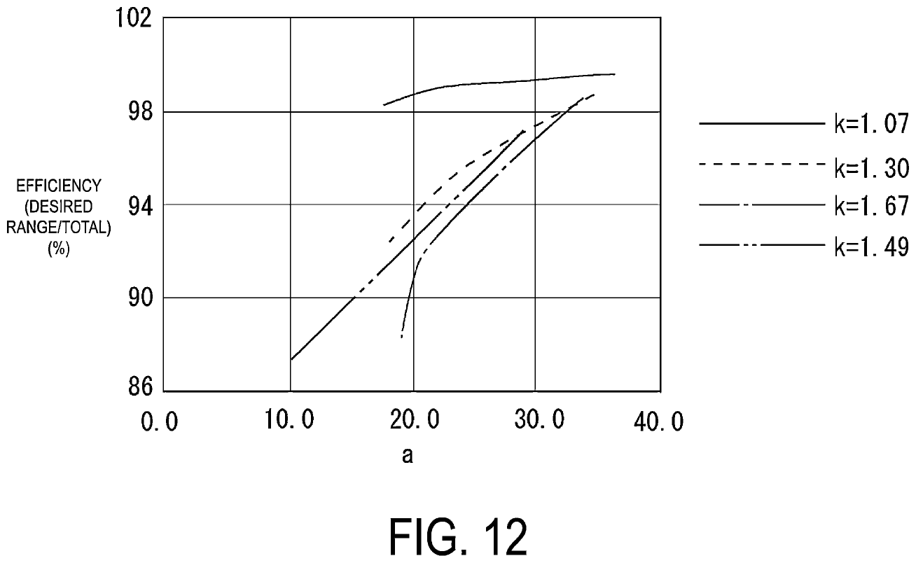

FIG. 12 shows the relationship between the parameter a, the aspect ratio k, and the efficiency (%) defined as the ratio of the intensity of the entire irradiation pattern to the intensity of the irradiation light in a desired range in which the light receiving element is assumed. In FIG. 12, the horizontal axis represents the parameter a, and the vertical axis represents the efficiency. As can be seen from FIG. 12, the efficiency increases as the value of the parameter a increases for all the aspect ratios k.

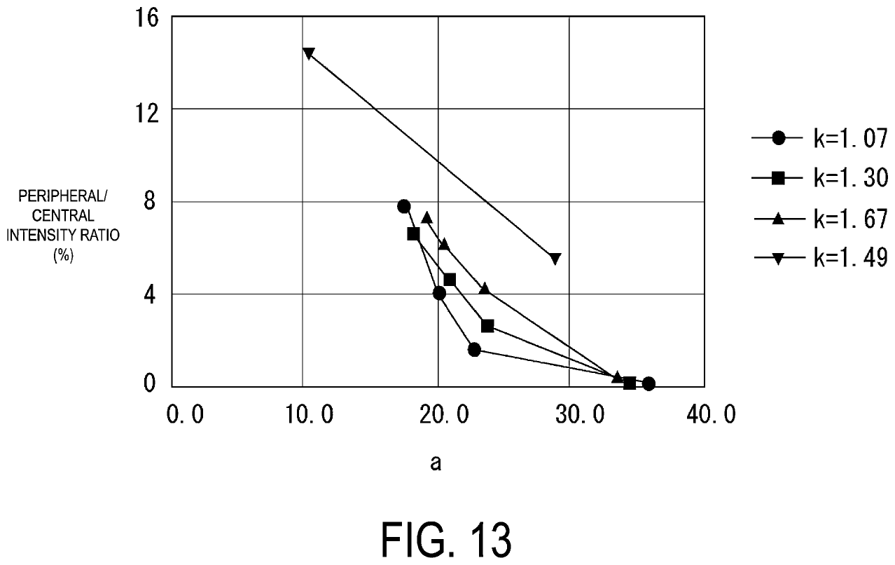

Next, FIG. 13 shows the relationship between the parameter a, the aspect ratio k, and the intensity ratio of irradiation light between the peripheral portion and the center of the light receiving surface of the light receiving element. In FIG. 13, the horizontal axis represents the parameter a, and the vertical axis represents the intensity ratio (%). As can be seen from FIG. 13, for all the aspect ratios k, the less the value of the parameter a, the greater the intensity ratio of the irradiation light between the peripheral portion and the center of the light receiving surface.

From the results of FIG. 12 and FIG. 13, it can be seen that when the value of the parameter a is in the range of 15≤a≤35, an irradiation pattern which can be sufficiently used can be obtained, and when the value of the parameter a is in the range of 20≤a≤30, the efficiency and the peripheral dimming can be well balanced, and better characteristics of the irradiation pattern can be obtained.

In the embodiment described above, the light emitted from the light source 2 passes through the micro lens array 5 and is projected onto the screen 3. Alternatively, the micro lens array 5 may be used in such a manner that the light emitted from the light source 2 is reflected on the micro lens array 1 and projected onto the screen 3.

Further, in the present embodiment, the example in which the lens elements 5a in the micro lens array 5 are arrayed on one surface on the light sources 2 side has been described, but the lens elements 5a may be arrayed on one surface on the side opposite to the light sources 2. Furthermore, the lens elements may be arrayed on both sides.

In addition, the cross section of each of the lens elements 5a has a shape such that the curved surface shapes are discontinuously arranged, but may have a shape such that the curved surface shapes are continuously connected to each other by a smooth curve.

Further, as for the material of the micro lens array 5 in the present embodiment, the base material and the lens elements 5a may be formed of different materials, or may be integrally formed of the same material. When the base material and the lens element 5a are formed of different materials, one of the base material and the lens element 5a may be formed of a plastic material, and the other may be formed of a glass material. When the base material and the lens elements 5a are integrally formed of the same material, there is no refractive-index interface, and thus the transmittance can be increased. In addition, reliability without peeling between the base material and each of the lens elements 5a can be improved. In this case, the micro lens array 5 may be formed of a resin alone or a glass alone.

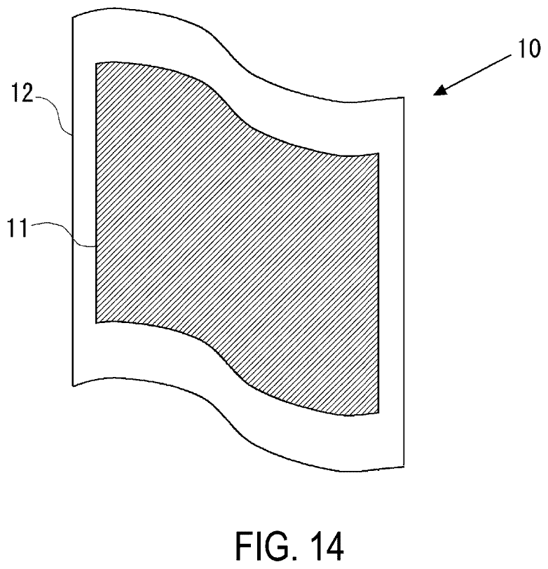

Further, as illustrated in FIG. 14, a micro lens array 11 having a function equivalent to that of the micro lens array 5 described in the present embodiment may be formed on a flexible sheet 12 to constitute a diffuser plate 10 for diffusing and uniformizing incident light. As a matter of course, the micro lens array 11 may be formed on a rigid flat plate to serve as a diffuser plate.

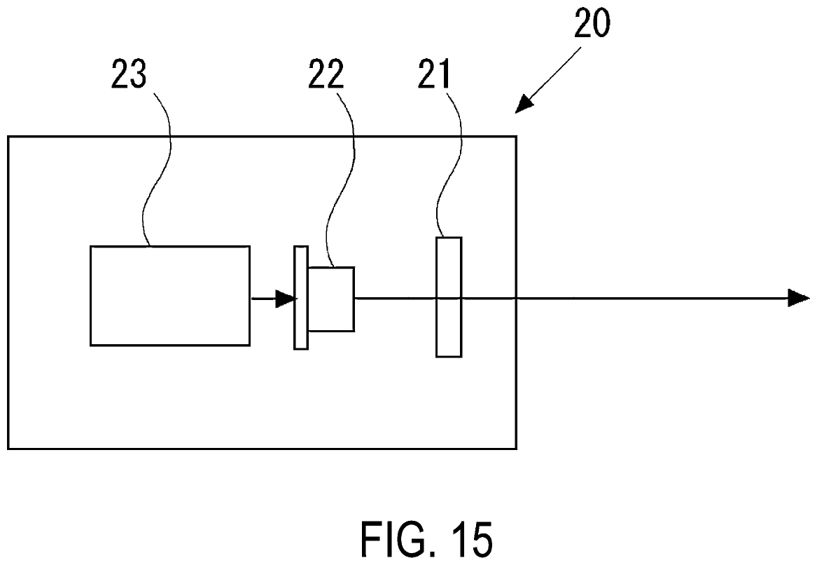

Further, as illustrated in FIG. 15, an illumination apparatus 20 may be configured by combining a micro lens array 21 having a function equivalent to that of the micro lens array 5 described in the present embodiment, a light source 22, and a light source control unit 23. The illumination apparatus 20 may be used alone for illumination or may be used by being incorporated into measuring equipment such as distance measuring equipment using the TOF system or another device. Further, in the illumination apparatus 20, the lens elements of the micro lens array 21 may be arranged on one surface on the light source 22 side, or may be arranged on one surface on the opposite side of the light source 22. The lens elements may be arranged on both sides. Further, the directivity of the light source 22 is not particularly limited, and for example, a light source having directivity of ±20° or less may be used. More preferably, the light source 22 with directivity of ±10° or less may be used. By using a light source having higher directivity as the light source 22, the irradiance distribution at both ends of the angle of view θ_{FOI} can be made to have a shape with a sharper edge.

Further, a micro lens array having a function equivalent to that of the micro lens array 5 described in the present embodiment may be used as an optical system for image capturing, face authentication in a security device, or space authentication in a vehicle or a robot. Furthermore, the micro lens array 1 described in the present embodiment may be used in combination with other optical elements including diffraction optical elements and refractive optical elements. Additionally, any coating may be applied to the surface of the micro lens array 1.

### Wiring of Conductive Substance

Wiring containing a conductive substance may be provided on the surfaces of or inside the micro lens array 5 according to the present embodiment, and thus damage to the lens elements 5a can be detected by monitoring the energization state of the wiring. By doing so, damage such as cracking or peeling of each of the lens elements 5a can easily be detected, and thus damage due to malfunction or erroneous operation of the illumination apparatus or the distance measuring equipment caused by damage to the micro lens array 5 can be prevented. For example, by detecting the occurrence of a crack in each of the lens elements 5a based on the disconnection of the conductive substance and prohibiting the light sources from emitting light, the zero order light from the light sources can be prevented from directly passing through the micro lens array 5 via the crack and being emitted to the outside. As a result, the eye safety performance of the apparatus can be improved.

The wiring of the conductive substance may be provided around the micro lens array 5 or on each of the lens elements 5a. Further, it may be applied to any one of the surface on which the lens elements 5a are formed, the surface on the opposite side, and both surfaces. The electrically conductive substance is not particularly limited as long as it has electrical conductivity, and for example, metal, metal oxide, electrically conductive polymer, an electrically conductive carbon-based substance, or the like can be used.

More specifically, the metal include gold, silver, copper, chromium, nickel, palladium, aluminum, iron, platinum, molybdenum, tungsten, zinc, lead, cobalt, titanium, zirconium, indium, rhodium, ruthenium, alloys thereof, and the like. Examples of the metal oxide include chromium oxide, nickel oxide, copper oxide, titanium oxide, zirconium oxide, indium oxide, aluminum oxide, zinc oxide, tin oxide, or composite oxides thereof such as composite oxides of indium oxide and tin oxide (ITO) and complex oxides of tin oxide and phosphorus oxide (PTO). Examples of the electrically conductive polymer include polyacetylene, polyaniline, polypyrrole, and polythiophene. Examples of the electrically conductive carbon-based substance include carbon black, SAF, ISAF, HAF, FEF, GPF, SRF, FT, MT, pyrolytic carbon, natural graphite, and artificial graphite. These electrically conductive substances can be used alone, or two or more types thereof can be used in combination.

The conductive substance is preferably a metal or a metal oxide, which is excellent in conductivity and easy to form wiring, more preferably a metal, preferably gold, silver, copper, indium, or the like, and silver is preferable because silver is mutually fused at a temperature of about 100° C. and can form wiring excellent in conductivity even on the micro lens array 5 made of a resin. A pattern and a shape of the wiring of the conductive substance are not particularly limited. A pattern surrounding the micro lens array 1 may be used, or a pattern with a more complicated shape may be used for the sake of higher detectability for the crack or the like. Further, a pattern in which at least a part of the micro lens array 5 is covered with a transparent conductive substance may be used.

### REFERENCE SIGNS LIST

1, 5, 11, 21 Micro lens array
1a, 5a Lens element
2 Light source
3 Screen
10 Diffuser plate
12 Flexible sheet
20 Illumination apparatus
22 Light source
23 Light source control unit
100 TOF distance measuring equipment
101 Light source control unit
102 Light source
103 Irradiation optical system
104 Light receiving optical system
105 Light receiving element
106 Signal processing circuit

1. A micro lens array in which a plurality of lens elements are arranged on at least one surface of a planar member, the micro lens array comprising:
a honeycomb structure including columns of the lens elements alternately arrayed, each of the lens elements having a shape of a hexagon in a plan view and being linearly arranged such that sides of the hexagon in a predetermined direction are in contact with each other, wherein
a mathematical expression indicating a SAG of the lens element includes a term of A_{xmyn}X^{m}Yⁿ (m and n are integers except 0), in a case where, when an optical axis of the lens element is an origin, Y is a coordinate in an arrangement direction of the lens elements in the columns of the lens elements, X is a coordinate in an array direction in which the columns of the lens elements are alternately arrayed, and A is a predetermined coefficient.

2. The micro lens array according to claim 1, wherein
a mathematical expression indicating the SAG of the lens element is represented by
$$\begin{matrix}[ Math . 1 ] & \\ Z = \frac{C {r}^{2}}{1 + \sqrt{1 - ( 1 + K ) {C}^{2} {r}^{2}}} + Σ {A}_{xmyn} {X}^{m} {Y}^{n} & ( 1 )\end{matrix}$$
where C is a curvature of a lens surface, and K is a conical coefficient of the lens surface.

3. The micro lens array according to claim 1, wherein
the integers m and n are even numbers.

4. The micro lens array according to claim 1, wherein
the mathematical expression indicating the SAG of the lens element includes a term of A_{x2y2}X²Y².

5. The micro lens array according to claim 1, wherein
a second pitch is greater than a first pitch, the second pitch being a pitch in an array direction in which the columns of the lens elements are alternately arrayed, the first pitch being a pitch of the plurality of lens elements in the arrangement direction of the lens elements in the columns of the lens elements.

6. The micro lens array according to claim 1, wherein
in the shape of the hexagon, an apex angle of two sides which are not in contact with front and rear lens elements in the columns of the lens elements is 125 degrees or less.

7. The micro lens array according to claim 1, wherein
an intensity pattern of light transmitted through the micro lens array has a substantially rectangular shape or a substantially quadrilateral shape such that each side is curved inward.

8. A diffuser plate comprising the micro lens array according to claim 1.

9. An illumination apparatus comprising:
the micro lens array according to claim 1; and
a light source configured to emit light incident on the micro lens array.

10. The illumination apparatus according to claim 9, wherein
the lens elements of the micro lens array are arrayed on a surface on a side close to the light source.

11. The illumination apparatus according to claim 9, wherein
directivity of the light source is ±20° or less.

12. The illumination apparatus according to claim 9, wherein
the light source is a laser light source configured to emit near-infrared light.

13. The illumination apparatus according to claim 9, wherein
the illumination apparatus being used in distance measuring equipment.

14. A micro lens array in which a plurality of lens elements are arranged on at least one surface of a planar member, the micro lens array comprising:
a honeycomb structure including columns of the lens elements are alternately arrayed, each of the lens elements having a shape of a hexagon in a plan view and being linearly arranged such that sides of the hexagon in a predetermined direction are in contact with each other, wherein
in a case where, when an optical axis of the lens element is an origin, a Y direction is an arrangement direction of the lens elements in the columns of the lens elements, and an X direction is an array direction in which the columns of the lens elements are alternately arrayed,
in a direction of a predetermined angle range between the X direction and the Y direction when viewed from the origin, the SAG in accordance with a distance r from the optical axis deviates from a range between the SAG in the X direction and the SAG in the Y direction.

15. The micro lens array according to claim 14, wherein
a second pitch is greater than a first pitch, the second pitch being a pitch in an array direction in which the columns of the lens elements are alternately arrayed, the first pitch being a pitch of the plurality of lens elements in the arrangement direction of the lens elements in the columns of the lens elements.

16. The micro lens array according to claim 14, wherein
in the shape of the hexagon, an apex angle of two sides which are not in contact with front and rear lens elements in the columns of the lens elements is 125 degrees or less.

17. The micro lens array according to claim 14, wherein
an intensity pattern of light transmitted through the micro lens array has a substantially rectangular shape or a substantially quadrilateral shape such that each side is curved inward.

18. A micro lens array in which a plurality of lens elements are arranged on at least one surface of a planar member, the micro lens array comprising:
a honeycomb structure in which columns of the lens elements are alternately arrayed, each of the lens elements having a shape of a hexagon in a plan view and being linearly arranged such that sides of the hexagon in a predetermined direction are in contact with each other, wherein
15≤a≤35 is satisfied where α is an apex angle of two sides which are not in contact with front and rear lens elements in the columns of the lens elements in the shape of the hexagon, k is an aspect ratio obtained by dividing a second pitch by a first pitch, the second pitch being a pitch of the plurality of lens elements in an array direction in which the columns of the lens elements are alternately arrayed, the first pitch being a pitch of the lens elements in an arrangement direction in the columns of the lens elements, and a is a value of (α−90)/k.

19. The micro lens array according to claim 18, wherein
a second pitch is greater than a first pitch, the second pitch being a pitch in an array direction in which the columns of the lens elements are alternately arrayed, the first pitch being a pitch of the plurality of lens elements in the arrangement direction of the lens elements in the columns of the lens elements.

20. The micro lens array according to claim 18, wherein
in the shape of the hexagon, an apex angle of two sides which are not in contact with front and rear lens elements in the columns of the lens elements is 125 degrees or less.
